(19) United States
(12) Patent Application Publication
(10) Pub. No.: US 2025/0356414 A1
(43) Pub. Date: Nov. 20, 2025

(54) SYSTEMS AND METHODS FOR DYNAMIC INCOMING RESOURCE ALLOCATION DELAY

(71) Applicant: Wells Fargo Bank, N.A., San Francisco, CA (US)

(72) Inventor: Frank Fehrenbach, San Francisco, CA (US)

(73) Assignee: Wells Fargo Bank, N.A., San Francisco, CA (US)

(21) Appl. No.: 18/667,117

(22) Filed: May 17, 2024

(51) Int. Cl. G06Q 40/02; G06F 3/0484; G06Q 30/0207

(52) U.S. Cl. CPC G06Q 40/02; G06F 3/0484; G06Q 30/0215

(57) ABSTRACT

A provider computing system includes at least one processing circuit. The processing circuit performs operations including receiving an indication of an incoming resource allocation associated with a user; retrieving user information relating to the incoming resource allocation; generating, based on the user information, a scale including a movable element for display via a user device associated with the user, the scale including one or more durations and one or more rewards associated with each of the one or more durations; updating and providing the generated scale based on at least one of the user information or contextual information; receiving, from the user via the user interface, a selected duration of the one or more durations; withholding the incoming resource allocation for the selected duration; and transmitting the incoming resource allocation and a reward subsequent to the selected duration.

### TECHNICAL FIELD

The present disclosure relates generally to incoming resource allocation, and more specifically to a delaying a triggering of the incoming resource allocation to a user (which may be in exchange for an incentive).

### BACKGROUND

Generally, employees (e.g., W2 employees) are paid by their employer according to a predetermined frequency (e.g., weekly, every other week, twice a month, etc.). That is, employees receive wages (e.g., via a direct deposit) according to that payment scheme. Early-wage access (EWA), however, allows employees to receive their wages in advance of the date prescribed by the payment scheme. An automated clearing house (ACH) posts a file including the incoming wages for a user a few days prior to when the wages are scheduled to arrive in the user's account. In this way, a financial institution (e.g., a bank) knows that the user is scheduled to receive the wages into the user's account prior to the scheduled payment date. For example, if a user is scheduled to get paid on a Friday, the financial institution may receive the notification of the incoming funds on Wednesday. Therefore, the financial institution knows that the funds are coming two days in advance of the actual arrival of the funds in the user's account. EWA gives the user early access to these funds as soon as the financial institution knows that the funds are coming (e.g., in this example, the user may receive access on Wednesday, rather than Friday). Certain financial institutions that offer EWA may charge a fee (e.g., $4) in order for a user to utilize this service. Although charging the fee for EWA may provide financial institutions with a source of funding, financial institutions primarily rely on deposits in order to comply with regulatory requirements (e.g., a liquidity coverage ratio, a tier 1 capital ratio, etc.). Therefore, EWA presents financial institutions with uncertainty regarding when a user may choose to receive access to their wages, causing more unpredictability with regard to financial institution deposits.

### SUMMARY

One embodiment relates to a provider computing system associated with a provider institution. The provider computing system includes at least one processing circuit having at least one processor coupled to at least one memory device. The at least one memory device stores instructions thereon that, when executed by the at least one processor, cause the at least one processing circuit to perform operations including: communicatively coupling to a third-party computing system by receiving a credential utilized by the third-party computing system and associated with a user; receiving an indication of an authentication of the credential and subsequently receiving an indication of an incoming resource allocation associated with the user; retrieving user information relating to the incoming resource allocation; generating, based on the user information, a scale including a movable element for display via a user device associated with the user, the scale including one or more durations and one or more rewards associated with each of the one or more durations; updating and providing the generated scale based on at least one of the user information or contextual information, the generated scale dynamically updating based on the incoming resource allocation and the at least one of the user information or the contextual information; receiving, from the user via the user interface, a selected duration of the one or more durations; withholding the incoming resource allocation for the selected duration; and transmitting the incoming resource allocation and a reward subsequent to the selected duration.

Another embodiment relates to a method. The method includes: communicatively coupling, by a provider computing system, to a third-party computing system by receiving a credential utilized by the third-party computing system and associated with a user; receiving, by the provider computing system, an indication of an authentication of the credential and subsequently receiving an indication of an incoming resource allocation associated with a user; retrieving, by the provider computing system, user information relating to the incoming resource allocation; generating, by the provider computing system, based on the user information, a scale including a movable element for display via a user device associated with the user, the scale including one or more durations and one or more rewards associated with each of the one or more durations; updating and providing, by the provider computing system, the generated scale based on at least one of the user information or contextual information, the generated scale dynamically updating based on the incoming resource allocation and the at least one of the user information or the contextual information; receiving, by the provider computing system, from the user via the user device, a selected duration of the one or more durations; withholding, by the provider computing system, the incoming resource allocation for the selected duration; and transmitting, by the provider computing system, the incoming resource allocation and a reward subsequent to the selected duration.

Still another embodiment relates to a non-transitory computer-readable medium having instructions stored thereon that, when executed by at least one processing circuit of a provider computing system associated with a provider institution, cause the at least one processing circuit to perform operations. The operations include: communicatively coupling to a third-party computing system by receiving a credential utilized by the third-party computing system and associated with a user; receiving an indication of an authentication of the credential and subsequently receiving an indication of an incoming resource allocation associated with a user; retrieving user information relating to the incoming resource allocation; generating, based on the user information, a scale including a movable element for display via a user device associated with the user, the scale including one or more durations and one or more rewards associated with each of the one or more durations; updating and providing the generated scale based on at least one of the user information or contextual information; receiving, from the user via the user interface, a selected duration of the one or more durations; withholding the incoming resource allocation for the selected duration; and transmitting the incoming resource allocation and a reward subsequent to the selected duration.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a provider computing system, according to an example embodiment.

FIG. 2 depicts a block diagram of an AI sub-system of FIG. 1 in greater detail, according to an example embodiment.

FIG. 3 depicts a block diagram of an AI model of the AI sub-system of FIG. 1, according to an exemplary embodiment.

FIG. 4 depicts a method of determining a dynamic incoming resource allocation delay with an incentive from a perspective of a provider computing system, according to an example embodiment.

FIG. 5 depicts a method of determining a dynamic incoming resource allocation delay with an incentive from a perspective of a user device, according to an example embodiment.

FIG. 6 depicts a graphical user interface, according to an example embodiment.

FIG. 7 depicts another graphical user interface, according to an example embodiment.

### DETAILED DESCRIPTION

Contrary to EWA and as described herein, a provider institution may offer and implement a delayed-wage access (e.g., a late-wage access, a premium-wage access, etc.) technical process that provides various technical advantages described herein. With the delayed-wage access, a user may choose to hold their wages as a deposit (e.g., prior to receiving a direct deposit into the user's account, for example) and may receive a higher amount of funds (e.g., due to accrued interest while the wages are held as a deposit) after the period of the delay. Delayed-wage access allows financial institutions to receive deposits with little expense to the financial institution (e.g., the cost of the interest rate on the funds). Beneficially and because financial institutions are constantly seeking deposits, offering delayed-wage access as described herein is a technical process of financing for financial institutions that also benefits the user (e.g., receiving more funds than if the user receives wages on time).

Existing technologies, however, fail to possess the components necessary to provide delayed-wage access without employing the use of multiple disparate systems and without occupying significant processing power. For example, a system configured to facilitate delayed-wage access for a customer requires communication with an employer to receive the indication of the delay, processing components configured to generate durations of the delay and corresponding incentives, and communication with a user device such that the user may receive and engage with options presented for the delayed wage access. More specifically, delayed wage access requires communication with a plurality of third-party entities (e.g., the employer, data sources for retrieving contextual information, providers eligible to offer the incentives offered to the user, etc.).

The systems, methods, and computer-implemented apparatuses described herein, however, provide a technical solution to at least the technical issues present in existing systems. That is, the systems, methods, and computer-implemented apparatuses described herein allow for provider institutions to generate personalized recommendations for a delayed wage access using reduced processing power and improving the bandwidth required therewith. For example, as described herein, a provider institution may be configured to access information (e.g., user account information, economic data, transaction history, etc.) from a plurality of data sources (e.g., provider entities, financial reports, etc.) for use in facilitating a delayed wage access for a user. Furthermore, the use of these data streams as described herein is not routine, well-understood, or conventional. For example, using employer data streams relating to a user as a trigger event for the provider institution to perform an action is not well-understood, routine, or conventional activity.

As another example, diverting funds from a third-party entity (e.g., the employer) to a destination other than the recipient's intended account is not well-understood, routine, or conventional activity. Additionally, improved graphical user interfaces for reflecting this diversion are described herein. Rather than interfacing with an employer to redirect/divert funds from an intended account, a user instead can interface with the provider institution alone to effectuate an unconventional manipulation of a resource transfer (e.g., a diversion of funds). By interfacing with the provider institution via these improved graphical interfaces, the systems, methods, and apparatuses described herein save computing power by reducing the amount of communications required to facilitate the resource transfer. That is, a user does not have to communicate with the employer to request the resource transfer and then with the provider institution to implement the resource transfer, both of which would require a separate communication with the employer and a separate communication with the provider institution. Rather, as described herein, the provider institution is configured to facilitate the resource transfer one central position using a secure method to receive information relating to the user from the employer. In this way, systems, methods, and apparatuses described herein increase processing capability while providing a secure data structure.

Furthermore, the systems, methods, and apparatuses described herein provide for an artificial intelligence model configured to provide recommendations of the delayed wage access. The recommendations (e.g., periods of delay) may be based on third-party data (e.g., income data from an employer) and user data (e.g., expense information associated with the user). The recommendations may further be generated based on previous delayed wage access options presented to/chosen by the user, thereby providing personalized services unavailable using existing technologies. Selectively providing the recommendations based on the third-party data and the user data to a user via a user interface is not a well understood, routine, or conventional activity.

The systems, methods, and computer-implemented apparatuses described herein provide improvements to deposit management processes for provider institutions as well. Deposits are typically the least expensive and most secure source of funding for financial institutions. However, maintaining steady deposits assumes that customers associated with the deposits do not intend to unexpectedly withdraw considerable amounts of their deposits held at the financial institution. Therefore, customer deposits pose a threat to risk management at financial institutions. For example, when news outlets indicate that a financial institution may be at risk of facing a financial crisis and/or that market conditions may suggest an impending collapse, customers may be more likely to suddenly withdraw their deposits from the financial institution. As another example, if a customer is faced with an unforeseen expense, the customer may need to withdraw their deposits from the financial institution in order to cover the unforeseen expense. Thus, financial institutions struggle to predict when a customer may withdraw their deposits. When customers do unexpectedly withdraw significant amounts of deposits, the financial institutions may also fail to meet strict regulatory requirements from the Fed (e.g., a liquidity coverage ratio, a tier 1 capital ratio, etc.).

With financial institutions facing the continuous threat of unexpected deposit withdrawals, an incentive structure designed to hold incoming deposits under the financial institution's control, rather than the customer's control, for a predetermined amount of time, may be deployed in advance of a problem. For example and as described herein, if a financial institution is short on cash and/or in need of deposits, the financial institutions could offer an incentive to the customer to keep their deposits in the financial institution. The incentive may be a real-time offer that depends on current conditions (e.g., a severity of the financial institution's position, market performance, etc.). Because this structure is dynamic and rate-driven, the incentive may be decided based on financial institution performance and regulatory thresholds (e.g., the financial institution could give higher incentives at quarter end to meet thresholds). Having such an incentive structure provides a benefit to the risk teams at financial institutions, as it provides a channel for receiving deposits for a predetermined amount of time.

The systems, methods, and computer-implemented apparatuses described herein also increase liquidity for the financial institutions (e.g., the financial institutions hold cash for a longer period, which contributes to meeting tier 1 capital standards, deposit ratios, and so on.). Therefore, the dynamic incentive structure is liquidity-driven (e.g., by a financial institution's performance with respect to regulatory requirements) and rate-driven (e.g., by overall market conditions/factors).

Additionally, the systems, methods, and computer-implemented apparatuses described herein benefit the customers because this allows the recipient of the direct deposit to earn more than the initial direct deposit amount, thereby rewarding/incentivizing the user for taking a delayed payment (i.e., a delayed receipt of a resource, such as cash or other currency). The incentive structure essentially provides a level of forced savings. In some cases, the systems, methods, and computer-implemented apparatuses described herein may also provoke account opening to house or hold the funds that are being held by the financial institution over the period of the delay. That is, the funds may be scheduled to arrive in a customer's checking account, but the customer may choose to hold the funds in a second account at the financial institution until the period of the delay expires.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

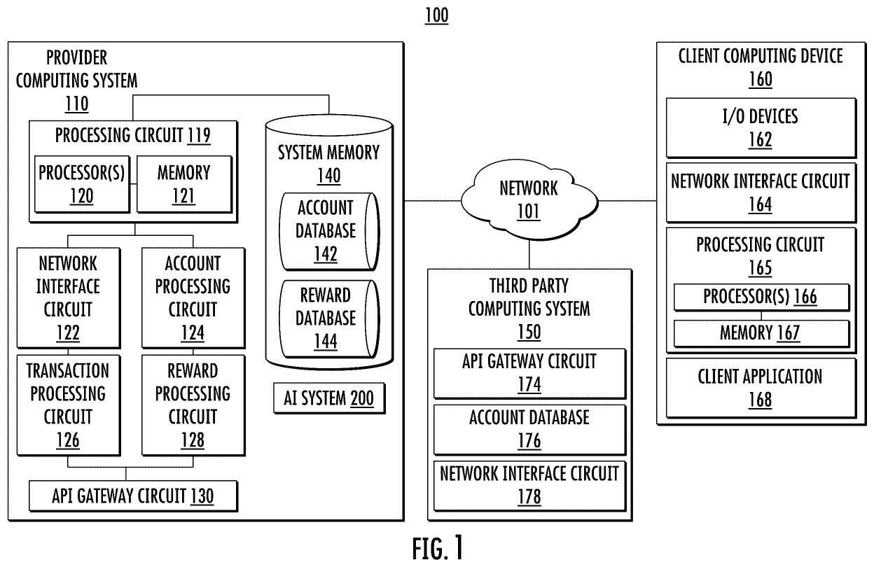

FIG. 1 is a diagram of a computing environment or system 100 for determining a duration for delaying a transferring of an incoming resource allocation to a user, according to an example embodiment. As shown, the system 100 includes a provider computing system 110, at least one third-party data source/computing system 150 (shown as one third-party computing system 150, but there may be a plurality), and at least one client computing device 160. The provider computing system 110, the third-party computing system 150, and the client computing device 160 are in communication with each other and are connected by a network 101.

The network 101 can include any type or form of one or more networks. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks. The network 101 can be of any such network topology as known to those ordinarily skilled in the art capable of supporting the operations described herein. The network 101 can utilize different techniques and layers or stacks of protocols, including, e.g., wired and/or wireless protocols, such as the Ethernet protocol, the Internet protocol suite (TCP/IP), the Asynchronous Transfer Mode technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network.

The provider computing system 110 is owned by, associated with, or otherwise operated by a provider institution (e.g., a bank or other financial institution) that maintains one or more accounts held by various users (e.g., a user associated with the client computing device 160), such as demand deposit accounts, credit card accounts, receivables accounts, and so on. In some instances, the provider computing system 110, for example, may include one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the provider computing system 110 may include and/or have various other devices communicably coupled thereto, such as, for example, desktop or laptop computers (e.g., tablet computers), smartphones, wearable devices (e.g., smartwatches), and/or other suitable devices.

In the example shown, the provider computing system 110 includes at least one of a processing circuit 119, a system memory 140, or an artificial intelligence (AI) system 200. Although not specifically shown, it may be appreciated that the provider computing system 110 may include one or more I/O devices. The one or more I/O devices are configured to receive inputs from and display information to a user. While the term “I/O” is used, it should be understood that the I/O devices may be input-only devices, output-only devices, and/or a combination of input and output devices.

The processing circuit 119 includes one or more processors 120 coupled to one or more memory device(s). The processing circuit 119 can include, but is not limited to, at least one microcontroller unit (MCU), microprocessor unit (MPU), central processing unit (CPU), graphics processing unit (GPU), physics processing unit (PPU), embedded controller (EC), and/or the like. The processing circuit 119 can include at least one memory 121 operable to store or storing one or more instructions for operating components of the processing circuit 119 and operating components operably coupled to the processing circuit 119. For example, the one or more instructions can include one or more of firmware, software, hardware, operating systems, embedded operating systems. The memory 121 may include one or more devices (e.g., RAM, ROM, Flash memory, hard disk storage) for storing data and/or computer code for completing and/or facilitating the various processes described herein. The memory 121 may include non-transient volatile memory, non-volatile memory, and non-transitory computer storage media, database components, object code components, script components, or any other type of information structure for supporting the various activities and information structures described herein.

The provider computing system 110 can include one or more communication bus controllers to effect communication between the processing circuit 119 and the other elements of the provider computing system 110. As shown, the provider computing system 110 includes a network interface circuit 122, an account processing circuit 124, a transaction processing circuit 126, a reward processing circuit 128, and an application programming interface (API) gateway circuit 130.

In some instances, the network interface circuit 122 includes, for example, program logic that connects the provider computing system 110 to the network 101. The network interface circuit 122 facilitates secure communications between the provider computing system 110 and the client computing device 160 and the third-party computing system 150. The network interface circuit 122 also facilitates communication with other entities, such as other financial institutions, settlement systems, and so on. The network interface circuit 122 further includes user interface program logic configured to generate and present web pages to users accessing the provider computing system 110 over the network 101.

The network interface circuit 122 may include one or more antennas and associated communications hardware. For example, the network interface circuit 122 may include a network antenna. The network interface circuit 122 further includes any one or more of a cellular transceiver (e.g., CDMA, GSM, LTE, etc.), a wireless network transceiver (e.g., 802.11X, ZigBee, WI-FI, Internet, etc.), and/or a combination thereof (e.g., both a cellular transceiver and a wireless network transceiver).

The account processing circuit 124 is structured or configured to perform a variety of functionalities or operations to enable, implement, and monitor various user activities (e.g., account processing, product registration processing, account monitoring, etc.) in connection with user information stored within an account database (e.g., account database 142). In some instances, the account processing circuit 124 performs various functionalities to enable account opening and/or closing actions, product registration and/or closing actions (e.g., registering for and/or closing a rewards account associated with a rewards service provided by the provider computing system 110 and/or the third-party computing system 150), account withdrawals and deposits (e.g., account credits and debits to checking and savings accounts), various user account tracking activities, and/or a variety of other services associated with and/or provided by the provider institution. In some instances, the account processing circuit 124 is configured to, for each user activity performed, automatically or nearly automatically pull user information pertaining to the user and the user account associated with the user activity and to transmit the user information to the reward processing circuit 128 to be used in an incoming resource allocation delay, as described herein below.

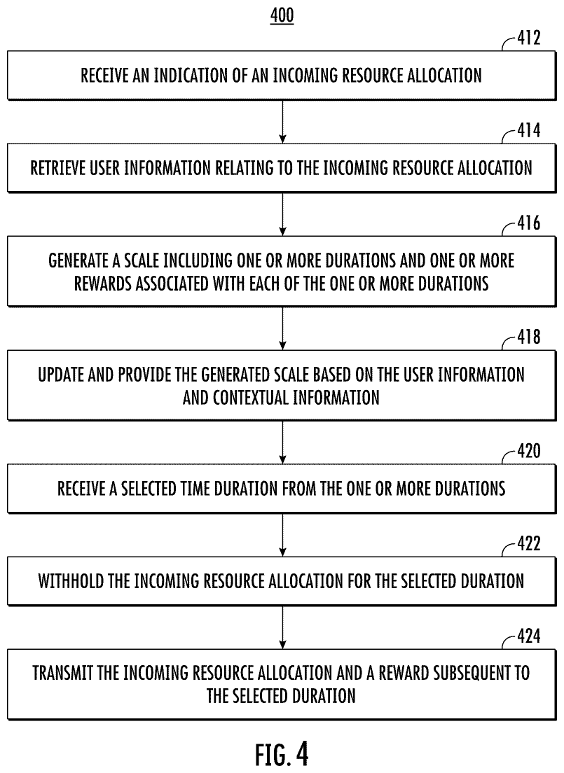

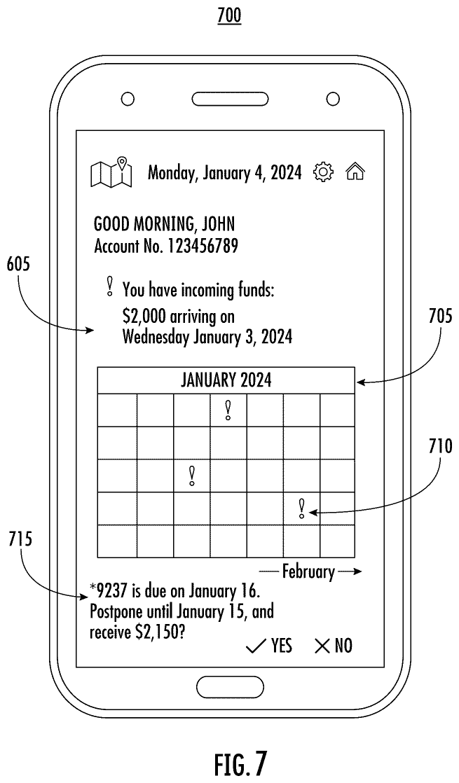

The transaction processing circuit 126 is structured or configured to enable and monitor various transactions (e.g., the user sending funds to a recipient, the user receiving funds from a sender) associated with or otherwise involving the accounts maintain by the provider computing system 110 (in the account database 142). In some instances, the transaction processing circuit 126 is further structured to incorporate at least some of the functionalities offered by the third-party computing system 150 (e.g., via one or more APIs and/or SDKs of the third-party computing system 150) to allow for customers to send and receive transfers of funds (e.g., via a client application 168 provided to the client computing device 160 by the provider computing system 110). Accordingly, in some instances, the transaction processing circuit 126 is further structured to enable and monitor various transactions and/or transfers conducted by the users that involve a third-party relative to the provider entity associated with the provider computing system (e.g., based on third-party accounts involving the third-party). For example, the transaction processing circuit 126 may detect that a user is scheduled to receive a direct deposit from the user's employer. In this case, the user's employer is a third-party relative to the provider and is associated with a third-party computing system 150. In some embodiments, the direct deposit may be included in the indication of the incoming resource allocation received at process 412 of method 400, as described below with reference to FIG. 4. As another example, the transaction processing circuit 126 may be configured to detect that a user is scheduled to pay a statement balance on a credit card associated with a third-party credit lender (e.g., another third-party of the third-party computing systems 150). In some embodiments, the scheduled payment may be indicated by the transaction indication 710 included on the transaction calendar 705 displayed via the graphical user interface (GUI) 700, as described below with reference to FIG. 7. Therefore, the transaction processing circuit 126 may be configured to determine, based on the incoming deposits and the scheduled payments associated with a user's account, an optimal (e.g., recommended, suggested, etc.) period over which the user may delay the transmittal of an incoming resource allocation (e.g., a wage) to the user's account.

The reward processing circuit 128 is structured to enable various functionalities described herein. For example, in some instances, the reward processing circuit 128 is structured to determine a reward or incentive corresponding to an incoming resource allocation delay, such as that which is described in detail below with respect to FIG. 4. In some instances, the reward processing circuit 128 is further structured to receive (e.g., automatically or nearly automatically upon various user activities and transactions) or pull (e.g., upon a predetermined schedule) various user activity information, user transaction information, user information, and/or contextual information from the account processing circuit 124, the transaction processing circuit 126, the account database 142, the reward database 144, and/or the third-party computing system 150 (e.g., the account database 176) to enable the reward determination.

The API gateway circuit 130 is structured or configured to facilitate the communication and exchange of content and data between the provider computing system 110, the third-party computing system 150, and the client computing device 160. The third-party computing system 150 and/or the client computing device 160 may include and/or execute API protocols that are used to establish an API session between the provider computing system 110 and the external devices. In this regard, the API protocols and/or sessions may allow the provider computing system 110 to communicate data (e.g., data regarding one or more services offered by the provider computing system 110) to be displayed/provided/rendered directly within the external devices. For example, the external device may activate an API protocol (e.g., via an API call), which may be communicated to the provider computing system 110 via the network 101 and the network interface circuit 122. The API gateway circuit 130 may receive the API call from the network interface circuit 122, and the API gateway circuit 130 may process and respond to the API call by providing API response data. The API response data may be communicated by the provider computing system 110 to the external device via the network interface circuit 122 and the network 101. The external device may then access (e.g., display/use/interface with) the API response data (e.g., one or more services offered by the provider institution) on the external device.

As such, the API gateway circuit 130 is structured or configured to initiate, receive, process, and/or respond to API calls (e.g., via the network interface circuit 122) over the network 101. That is, the API gateway circuit 130 may be configured to facilitate the communication and exchange of content and data between the external devices and the provider computing system 110. Accordingly, to process various API calls, the API gateway circuit 130 may receive, process, and respond to API calls using other circuits. Additionally, the API gateway circuit 130 may be structured to receive communications (e.g., API calls, API response data, etc.) from other circuits. That is, other circuits may communicate content and data to the provider computing system 110 via the API gateway circuit 130. Therefore, the API gateway circuit 130 is communicatively coupled to other circuits of the provider computing system 110, either tangibly via hardware, or indirectly via software.

The system memory 140 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. In this way, in some examples, the memory 121 of the processing circuit 119 may be included with the system memory 140 in some embodiments, and in other embodiments, a separate memory relative to the system memory 140. According to an exemplary embodiment, the system memory 140 is communicably coupled to the processing circuit 119 and includes computer code for executing (e.g., by the processing circuit 119 and/or the one or more processing circuits) one or more processes described herein. The system memory 140 may be or include tangible, non-transient volatile memory or non-volatile memory. The system memory 140 may also include database components, object code components, script components, or any other type of information structure for supporting the activities and information structures described in the present application.

In the example shown, the system memory 140 may further include an account database 142 and a reward database 144. In other embodiments, these databases may be separate from the system memory 140.

The account database 142 is structured or configured as a data or information repository that retrievably stores user account information associated with various user accounts held or otherwise maintained by the provider institution. In some instances, the user account information includes both user information and account information pertaining to a given user account. For example, in some instances, the user information may include a name, a phone number, an e-mail address, a physical address, an occupation, etc. of the user associated with the user account. In some instances, the account information may include transaction information, information pertaining to the type and corresponding capabilities of the given account, a transfer service token (e.g., a phone number, an e-mail address, or a tag associated with a particular transfer service account) associated with the user account, etc. As described in greater detail below, the account database 142 is configured to be used by the account processing circuit 124, the transaction processing circuit 126, and the reward processing circuit 128 to identify various user account information associated with various transactions and other activities (e.g., account openings and closings, document validations, fund transfers, etc.) to determine a period of delay of a transmittal of an incoming resource allocation and the corresponding reward associated with the period of delay.

The reward database 144 is a data or information repository structured or configured to retrievably store various reward or incentive information associated with users and corresponding user accounts held or otherwise maintained by the provider institution and/or a third-party provider (e.g., associated with the third-party computing system 150). The reward information refers to one or more eligible channels/means by which the user may receive a reward in exchange for a delayed transmittal of an incoming resource allocation. The eligible channels/means may refer to rewards offered by third-party entities with which the user has an account, rewards offered by third-party entities with which the provider institution is partnered, services offered by the provider institution in which the user is enrolled/eligible to be enrolled, and so on. The one or more rewards may include a discounted service, a discounted product, an interest rate earned on a deposit, bonus points earned in a rewards account, a credit voucher, and so on.

The discounted service and the discounted product may refer to a monetary discount (e.g., a dollar amount off, a percentage off, etc.) applied to a service/product offered by a provider entity. In some embodiments, the provider entity may be associated with the third-party computing system 150, as described below. In some embodiments, the provider entity may refer to the provider institution. The interest rate earned on the deposit may refer to a monetary amount accumulated based on a current interest rate retrieved from a third-party data source (e.g., the third-party computing system 150, as described below). The bonus points earned in a rewards account may refer to an amount of points (e.g., rewards, loyalty points, credit, etc.) associated with an account held at a provider entity (e.g., the provider institution, a third-party provider associated with the third-party computing system 150, etc.). In some embodiments, the points may be applied towards a product/service offered by the provider entity. For example, if the provider entity is an airline provider, the points (e.g., miles) may be applied towards a cost of a flight. As another example, if the provider entity is a restaurant, the points may be applied towards the cost of a menu item. As still another example, if the provider entity is the provider institution (e.g., a financial institution associated with the provider computing system 110), the points may be applied towards a statement balance associated with a credit card issued by the provider institution. The credit voucher refers to a balance (e.g., a monetary value) that a user may apply towards a product/service offered by the issuer of the credit voucher. For example, the issuer of the credit voucher may include a credit lender from which a user has received a credit card, and therefore the credit voucher may represent a balance that the user may use to pay off a statement balance owed to the credit lender.

In some embodiments, the reward database 144 may store a preferred/favorite rewards channel associated with a user account, such that rewards offered to the user associated with the user account may be in terms of the preferred rewards channel. For example, if a user designates an airline as a preferred rewards channel, the reward database 144 may store that preference in association with the user account such that the rewards presented to the user of the user account include offers for bonus miles from the airline.

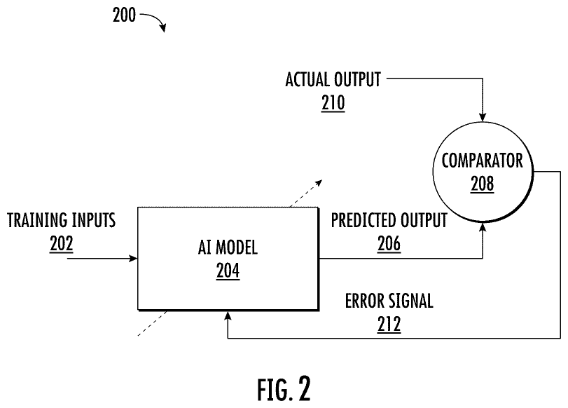

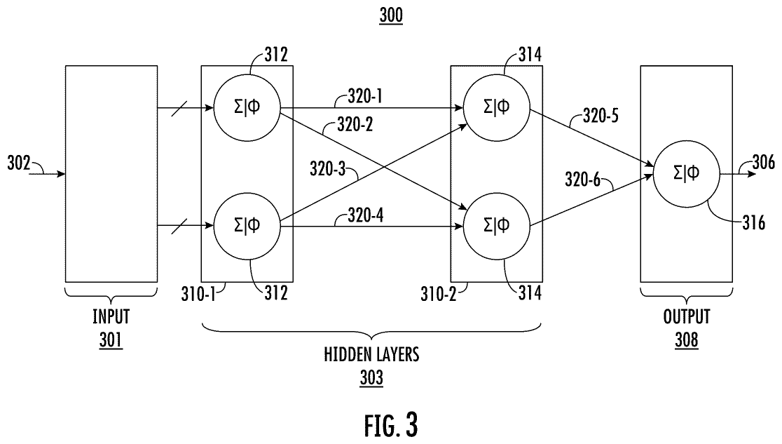

The AI system 200 may include one or more servers, databases, or cloud computing environments that may execute one or more AI models, and particularly AI models as described herein (e.g., AI model 204, as described in greater detail below with reference to FIGS. 2-3). The AI models may include, but are not limited to, large language models (LLMs), which can be trained to generate human-like text, speech, images, and/or components of graphical user interfaces. The AI models may be structured using a deep learning architecture that includes a multitude of interconnected layers, including attention mechanisms, self-attention layers, and transformer blocks. The AI models are trained on large datasets to assimilate patterns, structures, and relationships within the data. The trained AI models can be trained to generate outputs that resemble or closely resemble the characteristics of the input data. The AI models may be fine-tuned to generate specific output data, including data that is compatible with various database architectures or provider computing systems. The AI models can be trained via optimization of a large number of parameters, in which the AI models learn to minimize the error between its predictions and the actual data points, resulting in highly accurate and coherent generative capabilities.

In some embodiments, the system 100 may include one or more third-party computing systems 150. The third-party computing system 150 may refer to a computing system that is external to the provider computing system 110. In some embodiments, the system 100 may include a plurality of third-party computing systems 150 associated with a plurality of third-party entities. The third-party entity refers to an institution (e.g., a provider entity, such as a financial institution) that is a third-party relative to the provider institution. In some embodiments, the institution associated with the third-party computing system 150 may be an institution at which a user accessing the provider computing system 110 has an account. For example, the institution may include a credit lender, an airline provider, a retailer, a subscription service, and so on. The third-party computing system 150 may be configured to transmit data relating to the user (e.g., stored in the account database 176, as described below) to the provider computing system 110. In some embodiments, the institution associated with the third-party computing system 150 may be an institution with which the provider institution is partnered. For example, the provider institution may partner with one or more credit lenders, airline provider, retailers, subscription services, and so on, such that customers of the provider institution may receive one or more benefits from the partner institution. The one or more benefits received by the customers of the provider institution may include credit services, bonus airline miles, retail discounts, reduced subscription rates, and so on. In this example, a user may not be required to hold an account at the institution associated with the third-party computing system 150 in order to receive the one or more benefits of the partnership with the provider institution.

In some embodiments, the third-party computing system 150 may be associated with a third-party entity that is an employer of the user. The employer of the user refers to an entity (e.g., a business, an individual, an organization, etc.) by which the user is employed and from which the user receives a wage. In some embodiments, the employer may be configured to access an account (e.g., a checking account, a savings account, etc.) designated by and associated with the user, such that the employer may deposit the wage (e.g., an incoming resource allocation) for the user/employee into the designated financial account. For example, the employer may access the account by a routing number associated with the account. The user/employee may provide the routing number to the employer via an I-9 form. Therefore, the employer may be configured to transmit funds/wages to the user/employee to an account associated with the provider computing system 110 using the third-party computing system 150. In this way, the provider computing system 110 may be configured to receive an indication of an incoming resource allocation (e.g., a wage) from the third-party computing system 150 (e.g., the employer). In some embodiments, the transaction processing circuit 126 may be configured to receive the indication of the incoming resource allocation such that the provider computing system 110 may provide a recommended incoming resource allocation delay to the user.

In some embodiments, the third-party computing system 150 may be associated with a provider entity. The provider entity refers to an entity that offers one or more products and/or services to customers/users. In some embodiments, the entity may include a provider entity with which the user has an account. Alternatively or additionally, the entity may include a provider entity with which the user does not have an account. As described above, the entity may further include a provider entity with which the provider institution is partnered. The entity may include a retail provider, an airline provider, a credit lender, or any other third-party provider that is a distinct entity from the provider institution associated with the provider computing system 110. In some embodiments, the entity may provide user information relating to an account held at the entity and associated with the user. For example, the user information may include a points balance, a membership status, a transaction history, and so on. In some embodiments, the user information may be stored in the account database 176, as described below. The third-party computing system 150 may be configured to communicate the user information (e.g., via the API gateway circuit 174, the network interface circuit 178) to the provider computing system 110. In some embodiments, the reward processing circuit 128 may be configured to receive the user information from the third-party computing system 150 to determine one or more rewards associated with one or more durations included in an incoming resource allocation delay, as described herein. In some embodiments where a user does not have an account at the provider entity associated with the third-party computing system 150, the provider entity may be configured to provide information relating to one or more discounts/offers on the one or more products and/or services offered by the provider entity. Similarly, these one or more discounts/offers may be communicated too the provider computing system 110 such that the reward processing circuit 128 may use the information from the third-party computing system to determine the one or more rewards associated with one or more durations included in the incoming resource allocation delay.

In some embodiments, the third-party computing system 150 may be associated with a third-party data source. The third-party data source may include a financial journal, an economic report, a news article, a government memorandum, and so on. The third-party data source may be configured to provide information related to market conditions and/or other contextual data relevant in determining a delayed transmittal of an incoming resource allocation. The contextual information may include real-time economic metrics such as interest rates, gross domestic product (GDP), unemployment rates, inflation rates, and any other economic indicator. The contextual information may also include regulatory requirements, statutes, policies, and any other guidelines regarding the operation of a financial institution. For example, the provider computing system 110 may retrieve information relating to market data, interest rates, regulatory requirements, and so on, from the third-party computing system 150. With this information, the provider computing system 110 (e.g., the reward processing circuit 128) may be configured to determine a liquidity-driven (e.g., using the information related to regulatory requirements) and a rate-driven (e.g., using the information related to market data and economic metrics) incentive structure.

As shown in FIG. 1, the third-party computing system 150 may include an API gateway circuit 174, an account database 176, and a network interface circuit 178. In some embodiments, the API gateway circuit may include one or more APIs communicably coupled to/managed by/or otherwise associated with the third-party computing system 150. In some embodiments, the one or more APIs may be an API associated with one or more programs, services, applications, etc., offered by the third-party computing system 150 to one or more users enrolled in such corresponding one or more programs, services, applications, etc. The API gateway circuit 174 may be similar/identical to the API gateway circuit 130 of the provider computing system 110, as described above. For example, the third-party computing system 150 may activate the API protocol, which may be communicated to the provider computing system 110 via the network 101 and the network interface circuits 122/178.

The third-party computing system 150 is also shown to include an account database 176. The account database 176 is a data/information repository that is structured or configured to retrievably store user account information associated with various user accounts held or otherwise maintained by the third-party computing system 150. In some instances, the user account information includes both user information and account information pertaining to a given user account. For example, in some instances, the user information may include a name, a phone number, an e-mail address, a physical address, an occupation, etc. of the customer associated with the customer account. In some instances, the account information may include transaction information, information pertaining to the type and corresponding capabilities of the given account, a transfer service token (e.g., a phone number, an e-mail address, or a tag associated with a particular transfer service account) associated with the user account, etc.

The third-party computing system 150 may include the network interface circuit 178, which may be similar/identical to the network interface circuit 122 of the provider computing system 110, as described above. For example, the network interface circuit 178 includes program logic and various devices (e.g., transceivers, etc.) that connect the third-party computing system 150 to the network 101. In some instances, the program logic interfaces with one or more transceivers (e.g., Bluetooth, Wi-Fi, or any other suitable communication transceivers) to enable connection with the network 101. The network interface circuit 178 facilitates secure communications between the third-party computing system 150 and the provider computing system 110. The network interface circuit 178 also facilitates communication with other entities, such as other financial institutions, settlement systems, and so on (e.g., the provider computing system 110, the client computing device 160, etc.).

The user device or client computing device 160 is owned, operated, controlled, managed, and/or otherwise associated with a user. In the example shown, the user is a customer of the provider institution. As such, the user may have one or more accounts that are stored by the account database 142 at the provider computing system 110. In some embodiments, the client computing device 160 may be or may include, for example, a desktop or laptop computer (e.g., a tablet computer), a smartphone, a wearable device (e.g., a smartwatch), a personal digital assistant, and/or any other suitable computing device. In the example shown, the client computing device 160 is structured as a mobile computing device, namely a smartphone.

In some embodiments, the client computing device 160 includes one or more I/O devices 162, a network interface circuit 164, a processing circuit 165, and at least one client application 168. Again, while the term “I/O” is used, it should be understood that the I/O devices 162 may be input-only devices, output-only devices, and/or a combination of input and output devices. In some instances, the I/O devices 162 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 162 further include one or more user interfaces (devices or components that interface with the customer), which may include one or more biometric sensors (such as a fingerprint reader, a face scanner, an iris scanner, etc.).

The network interface circuit 164 includes, for example, program logic and various devices (e.g., transceivers, etc.) that connect the client computing device 160 to the network 101. The network interface circuit 164 facilitates secure communications between the client computing device 160 and each of the provider computing system 110 and the third-party computing systems 150. The network interface circuit 164 also facilitates communication with other entities, such as other financial institutions, settlement systems, and so on.

In some embodiments, the client computing device 160 may include a processing circuit 165. The processing circuit 165 includes one or more processors 166 coupled to one or more memory device(s). The processing circuit 165 can include, but is not limited to, at least one microcontroller unit (MCU), microprocessor unit (MPU), central processing unit (CPU), graphics processing unit (GPU), physics processing unit (PPU), embedded controller (EC), and/or the like. The processing circuit 165 can include at least one memory 167 operable to store or storing one or more instructions for operating components of the processing circuit 165 and operating components operably coupled to the processing circuit 165. For example, the one or more instructions can include one or more of firmware, software, hardware, operating systems, embedded operating systems. The memory 167 may include one or more devices (e.g., RAM, ROM, Flash memory, hard disk storage) for storing data and/or computer code for completing and/or facilitating the various processes described herein. The memory 167 may include non-transient volatile memory, non-volatile memory, and non-transitory computer storage media, database components, object code components, script components, or any other type of information structure for supporting the various activities and information structures described herein.

The client computing device 160 stores in the memory 167 and executes (“runs”) using the one or more processor(s) 166, the client application 168. The client computing device 160 may also execute a variety of other applications, such as an Internet browser application, a text messaging application (e.g., for sending MMS or SMS to the provider computing system 110 and/or the third-party computing system 150), and/or an application provided or authorized by entities implementing or administering certain of the operations described herein.

In the example shown, the client application 168 is a provider institution client application provided by and at least partly supported by the provider computing system 110 (e.g., a financial institution banking application, such as a mobile banking application). For example, in some instances, the client application 168 is coupled to the provider computing system 110 and may enable the user to perform various user activities (e.g., account management, account opening and/or closing actions, account withdrawals and deposits) and/or perform various transactions (e.g., the customer sending funds to a recipient, the customer receiving funds from a sender, etc.) associated with one or more user accounts of the user held at the provider institution associated with the provider computing system 110 (e.g., stored in the account database 142).

The client application 168 provided by the provider computing system 110 may additionally be coupled to the third-party computing system 150 (e.g., via one or more API(s) and/or software development kits (SDKs)) to integrate one or more features or services provided by the third-party computing system 150. For example, in some instances, the provider computing system 110 may integrate a rewards program provided by the third-party computing system 150 into the client application 168. The rewards program refers to a service by which a user may register an account with the third-party provider and accumulate rewards related to a particular product/service (e.g., restaurant points, airline miles, etc.) offered by the third-party provider. In some other instances, the third-party computing system 150 may alternatively provide the rewards program via a separate client application 168. Accordingly, the client application 168 is structured to provide the user with access to various services offered by the provider institution and/or the third-party provider.

In some embodiments, the client application 168 is hard coded into the memory of the client computing device 160. In some embodiments, the client application 168 is a web-based interface application, where the user has to log onto or access the web-based interface before usage, and these applications are supported by a separate computing system comprising one or more servers, processors, network interface circuits, or the like (e.g., the provider computing system 110, the third-party computing system 150), that transmit the applications for use to the client computing device 160.

Referring now to FIG. 2, a block diagram of the AI system 200 using supervised learning is shown, according to an example embodiment. The AI system 200 may include at least one AI model 204. Supervised learning is a method of training an AI model (e.g., the AI model 204) given input-output pairs. An input-output pair is an input with an associated known output (e.g., an expected output). More specifically, the AI model 204 may provide a method of supervised learning that, upon being trained by a plurality of input-output pairs, is configured to generate outputs based on unknown inputs.

The AI model 204 may be trained based on general data and/or granular data (e.g., data based on a specific user) such that the AI 204 may be trained specific to a particular user (e.g., a user with a user account at the provider institution). In some instances, the granular data refers to at least one of data from internal data source(s) (e.g., the account database 142 and/or the reward database 144) or external data source(s) (e.g., the third-party computing system 150).

The training inputs 202 and the actual outputs 210 may be provided to the AI model 204 as a training dataset. The training dataset refers to data used to train the AI model 204 to generate recommended delays of a transmittal of an incoming resource allocation. The training inputs 202 and the actual outputs 210 may be received from one or more data sources of the system 100. The one or more data sources may include one or more internal data sources (e.g., the account database 142 and/or the reward database 144) and/or one or more external data sources (e.g., third-party computing system 150, the client computing device 160, etc.). The one or more internal data sources refer to data sources of the provider computing system 110. The one or more external data sources refer to third-party computing system information that may be accessible over the network 101. For example, the one or more internal data sources may provide account information associated with a user, a transaction history, a transaction schedule (e.g., transaction calendar 705), parameters relating to transactions included in the transaction history (e.g., a timestamp, a transaction type, a transaction amount, or one or more parties associated with the transaction, etc.), and so on. The one or more external data sources, such as third-party computing systems 150, may provide account information relating to a rewards account of the user (e.g., stored in the account database 176), contextual information, regulatory requirements (e.g., liquidity ratios, tier 1 capital ratios, etc.), and so on. The contextual information may refer to real-time market rates and other performance metrics. Thus, the AI model 204 may be trained to suggest a delay of a transmittal of an incoming resource allocation based on the training inputs 202 and the actual outputs 210 used to train the AI model 204.

In some embodiments, the AI model 204 may be trained to make one or more recommendations to the user based on current user data received from at least one of the processing circuit 119, the system memory 140, the third-party computing system 150, or the client computing device 160. That is, the AI model 204 may be trained using the training inputs 202, such as the transaction history associated with the one or more accounts associated with the user, to predict outputs 206, such as one or more suggested deposit delays, by applying the current state of the AI model 204 to the training inputs 202. The current state of the AI model 204 refers to the predictive capacity of the AI model 204 based on the training that the AI model 204 has received thus far. For example, when a user first enrolls in an account at the provider institution, the current state of the AI model 204 may be one that has not been trained using data particular to that user, so the predictive capacity of the AI model 204 may be less accurate than the predictive capacity of the AI model 204 once the user has engaged in a plurality of transactions with the provider institution. The comparator 208 may compare the predicted outputs 206 to actual outputs 210 (e.g., one or more previous deposit delays) to determine an amount of error or differences. The actual outputs 210 may be determined based on historic data associated with the recommendation to the user (e.g., data indicating whether the deposit delay previously recommended to the user was chosen or not).

In some embodiments, the AI model 204 may be trained using a history of recommendations provided to the user (e.g., a history of previous incoming resource allocation delays). The history of recommendations may be stored in the system memory 140 (e.g., the account database 142, the reward database 144) and/or the client computing device 160 (e.g., the client application 168). The AI model 204 may be trained to identify, from the history of recommendations provided to the user, one or more durations and corresponding rewards associated with a previous recommendation selected by the user. Then, the AI model 204 may provide recommended durations and corresponding rewards resembling the durations and corresponding rewards previously selected by the user. For example, the AI model 204 may determine that the user previously selected durations exceeding a particular amount of time (e.g., longer than two weeks). In this example, the AI model 204 may be configured to provide recommended durations including amounts of time that also exceed the particular amount of time that has been exceeded throughout the previously selected durations (e.g., periods of time longer than two weeks).

In some embodiments, the AI model 204 may be trained to make the one or more recommendations based on contextual information retrieved from one or more third-party data sources (e.g., a financial journal, an economic report, a news article, a government memorandum, etc.). The third-party data source may provide information related to market conditions and/or other contextual data relevant in determining a delayed transmittal of an incoming resource allocation. The contextual information may include real-time economic metrics such as interest rates, gross domestic product (GDP), unemployment rates, inflation rates, and any other economic indicator. The contextual information may also include regulatory requirements, statutes, policies, and any other guidelines regarding the operation of a financial institution. Therefore, the AI model 204 may be trained to generate, based on the contextual information, a recommended incoming resource allocation delay. The recommended incoming resource allocation delay may be configured to provide a particular benefit to the provider institution and/or to the user. For example, a regulatory requirement retrieved from a government memorandum may reveal that a government agency may provide a subsidy to a financial institution that exceeds a required reserve ratio (e.g., a ratio of reserves to deposits) within a period of time. Based on this information, the AI model 204 may generate a recommended duration of delay that allows the financial institution to withhold the incoming resource allocation for the period of time within which the financial institution is to exceed the required reserve ratio in order to receive the subsidy. As another example, the AI model 204 may be configured to identify, from the contextual information, that inflation rates are high. Based on the high inflation rates, the AI model 204 may be trained to recommend rewards in terms of an interest rate earned on a deposit amount. That is, the AI model 204 may be trained to understand that high inflation rates are often counteracted against with high interest rates, meaning the user will receive a higher interest rate on the deposit amount when contextual information reveals that inflation rates are high than if contextual data reveals that inflation rates are low.

During training, the error (represented by error signal 212) determined by the comparator 208 may be used to adjust the weights in the AI model 204 such that the AI model 204 changes (or learns) over time. The AI model 204 may be trained using a backpropagation algorithm, for instance. The backpropagation algorithm operates by propagating the error signal 212. The error signal 212 may be calculated each iteration, batch and/or epoch, and propagated through the algorithmic weights in the AI model 204 such that the algorithmic weights adapt based on the amount of error. The error is minimized using a loss function. Non-limiting examples of loss functions may include the square error function, the root mean square error function, and/or the cross-entropy error function.

The weighting coefficients of the AI model 204 may be tuned to reduce the amount of error, thereby minimizing the differences between (or otherwise converging) the predicted output 206 and the actual output 210. The AI model 204 may be trained until the error determined at the comparator 208 is within a certain threshold (or a threshold number of batches, epochs, or iterations have been reached). The trained AI model 204 and associated weighting coefficients may subsequently be stored in a memory device or other data repository (e.g., a database) such that the AI model 204 may be employed on unknown data (e.g., not training inputs 202). Once trained and validated, the AI model 204 may be employed during a testing (or an inference phase). During testing, the AI model 204 may ingest unknown data to predict future data.

Referring to FIG. 3, a block diagram of a simplified neural network model 300 is shown, according to an example embodiment. The neural network model 300 may be implemented and utilized by the AI system 200. The neural network model 300 may include a stack of distinct layers (vertically oriented) that transform a variable number of inputs 302 being ingested by an input layer 301, into an output 306 at the output layer 308. For example, the variable number of inputs 302 may be retrieved from any of the one or more data sources (e.g., the one or more internal data sources and/or the one or more external data sources). As described above, the one or more internal data sources may provide account information associated with a user, a transaction history, and so on. The one or more external data sources may provide account information relating to a rewards account of the user (e.g., stored in the account database 176), contextual information, regulatory requirements (e.g., liquidity ratios, tier 1 capital ratios, etc.), and so on. The output 306 may include one or more suggested deposit delays based on the variable number of inputs 302.

The neural network model 300 may include any number of hidden layers 310 between the input layer 301 and output layer 308. Each hidden layer has a respective number of nodes (312, 314 and 316). In the neural network model 300, the first hidden layer 310-1 has nodes 312, and the second hidden layer 310-2 has nodes 314. The nodes 312 and 314 perform a particular computation and are interconnected to the nodes of adjacent layers (e.g., nodes 312 in the first hidden layer 310-1 are connected to nodes 314 in a second hidden layer 310-2, and nodes 314 in the second hidden layer 310-2 are connected to nodes 316 in the output layer 308). Each of the nodes (312, 314 and 316) sum up the values from adjacent nodes and apply an activation function, allowing the neural network model 300 to detect nonlinear patterns in the inputs 302. For example, each of the nodes (312, 314, and 316) may be configured to perform an analysis (e.g., detect patterns, identify trends, perform semantic analysis, etc.) on each of the variable number of inputs 302 (e.g., a transaction history, parameters surrounding a transaction request, account information, contextual information, etc.). Each of the nodes (312, 314 and 316) is interconnected by weights 320-1, 320-2, 320-3, 320-4, 320-5, 320-6 (collectively referred to as weights 320). Weights 320 are tuned during training to adjust the strength of the node. The adjustment of the strength of the node facilitates the neural network's ability to predict an accurate output 306.

For example, contextual information providing real-time interest rates may provide a more accurate indication of a user's preferred deposit delay than a transaction history associated with the user's account. The contextual information may be received from a third-party computing system 150 (e.g., a financial journal, an economic report, market analytics, etc.), as described above. In this example, a node configured to analyze real-time interest rates in the contextual information may be connected to a heavier weight than a node configured to detect patterns in a user's transaction history, therefore increasing the strength of the node that analyzes contextual information such that the output 306 is more heavily influenced by the contextual information than by the transaction history. The output 306 may thereafter be communicated to the reward processing circuit 128 such that the recommended deposit delays and corresponding rewards accurately reflect the user's preferences. After being received by the reward processing circuit 128, the output 306 may be transmitted to the client computing device 160 and included in a dynamic scale (e.g., scale 610) presented to the user on a GUI (e.g., GUI 600) via the client application 168.

In some embodiments, the output 306 may be one or more numbers. For example, output 306 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

With an example structure of the system 100 being described above, example processes performable by the system 100 (or components/systems thereof) are described below. It should be appreciated that the following processes are provided as examples and are in no way meant to be limiting. Additionally, various method processes discussed herein may be performed in a different order or, in some instances, completely omitted. These variations have been contemplated and are within the scope of the present disclosure.

Referring now to FIG. 4, a flow diagram of a method 400 for determining a dynamic incoming resource allocation delay is shown, according to an example embodiment. Various operations of the method 400 may be conducted by the system 100 and particularly parts thereof (e.g., the provider computing system 110, the client computing device 160, and the third-party computing system 150). It should be understood that not all methods steps may be performed to “complete” the method. Certain steps/processes may be omitted in other embodiments, and still fall within the scope of the present disclosure.

Although not shown in FIG. 4, method 400 may include the provider computing system 110 communicatively coupling to the third-party computing system 150 (e.g., via the network 101). In this way, the provider computing system 110 may be configured to utilize data streams from the third-party computing system 150 to perform activities, as described herein, that are not well-understood, routine, or conventional. For example, by communicatively coupling to the third-party computing system 150, the provider computing system 110 may use data from an employer as a trigger event in order to initiate incoming resource allocation delays, as described herein. Furthermore, communicatively coupling to the third-party computing system 150 allows the user to communicate directly with the provider institution (e.g., via the client computing device 160) to divert an incoming resource allocation (e.g., by selecting a duration of an incoming resource allocation delay, as described herein), rather than communicating with the employer and the provider institution separately. This direct communication improves bandwidth by reducing the amount of communications required to initiate and complete the incoming resource allocation delay.

In some embodiments, the provider computing system 110 communicatively couples with the third-party computing system 150 by receiving a credential (e.g., a password, a PIN, a biometric scan, a user ID, etc.) utilized by the third-party computing system 150 and associated with the user. For example, the provider computing system 110 may receive, as an input from the user via the client application 168, an employee PIN code unique to the user and utilized by the third-party computing system 150 (e.g., an employer) to identify the user. The provider computing system 110 may be configured to receive an indication of an authorization of the credential from the third-party computing system 150. That is, upon receiving the credential via the client application 168, the provider computing system 110 may automatically communicatively couple to the third-party computing system 150 and may transmit a request for the third-party computing system 150 to authenticate the credential received via the client application 168. Allowing for authentication of the credential utilized by the third-party computing system 150 and associated with the user provides a secure method for diverting an incoming resource allocation from the third-party computing system 150 using a single communication with the provider computing system 110 (e.g., via graphical user interfaces provided to the client computing device 160 via client application 168).

As shown in FIG. 4, the method 400 may include the provider computing system 110 receiving an indication of an incoming resource allocation at process 412. The provider computing system 110 may receive the indication of the incoming resource allocation subsequent to receiving the indication of the authentication of the credential, as described above. The incoming resource allocation refers to a future (e.g., upcoming, etc.) deposit of a resource (e.g., funds such as cash or another currency) and/or another resource (e.g., a line of credit, a financial security, a number of rewards points, etc.) into an account of a user held at the provider institution. For example, the account of the user may be one of the accounts (e.g., a demand deposit account) stored in the account database 142. In some embodiments, the provider computing system 110 may receive the indication of the incoming resource allocation from the third-party computing system 150 (associated with a third-party entity such as an automatic clearing house (ACH)). In this case, the provider computing system 110 may receive the indication as a notification based on an ACH file including one or more pending deposits associated with the account of the user is transmitted to the provider computing system 110. In this way, the third-party computing system 150 may be configured to transfer the ACH file via the API gateway circuits 130 and 174 of the provider computing system 110 and the third-party computing system 150, respectively.

After receiving the indication of the incoming resource allocation at process 412, the provider computing system 110 may be configured to retrieve user information relating to the incoming resource allocation at process 414. More specifically, the user information may be retrieved by the account processing circuit 124. The user information may include information stored in the account database 142 of the provider computing system 110. In some embodiments, the provider computing system 110 may send a message to a third-party computing system 150 for user information stored by the account database 176 of the third-party computing system 150.

Upon retrieving and/or receiving the user information at process 414, the provider computing system 110 may be configured to generate a scale including one or more durations and one or more rewards/incentives associated with each of the one or more durations. In some embodiments, the one or more durations may include a time duration. The time duration refers to a period of time (e.g., ten hours, two days, one week, one month, etc.) during which a user may choose to delay a transmittal of the incoming resource allocation. In some embodiments, the time duration may be inversely proportional to an amount of the incoming resource allocation. For example, if the incoming resource allocation includes a deposit of funds (e.g., $1,000,000.00), the time duration may include a time delay (e.g., one hour) corresponding to the amount indicated by the deposit of funds (e.g., $1,000,000). If the incoming resource allocation includes a deposit of funds of a lesser amount (e.g., $100), however, the time duration may include a shorter time delay (e.g., three days). In this example, a shortest time delay associated with the lesser amount may include a longer time duration (e.g., the three days) than a shortest time delay associated with the larger amount (e.g., the one hour).

The one or more durations may further include an event. In this usage, an event refers to a condition/circumstance which, when met, may cause a delayed access to the incoming resource allocation. For example, the event may refer to a market condition (e.g., the stock market rises ten points, interest rates reach 5%, etc.) that, when met, causes a delayed incoming resource allocation so long as the condition indicated by the event (e.g., the stock market condition, the interest rates condition, etc.) is met. In other words, a user may choose to delay access to an incoming resource allocation for a period extending from when the event begins (e.g., once the stock market rises ten points, once interest rates reach 5%, etc.) to when the event/condition/circumstance ends (e.g., once the stock market falls below the ten-point raise, once the interest rates fall below 5%, etc.).

In some embodiments, the one or more durations may include a period of time and an event. That is, the duration may refer to a period of time (e.g., ten hours, two days, one week, one month, etc.) that is initiated once an event has been detected (e.g., the stock market rises ten points, interest rates reach 5%, etc.). In other words, the one or more durations may include a delay of one week once the interest rates reach 5%. In some embodiments, the AI model 204 may be configured to determine the one or more durations to include in the generated scale, as described above with reference to FIGS. 2 and 3.

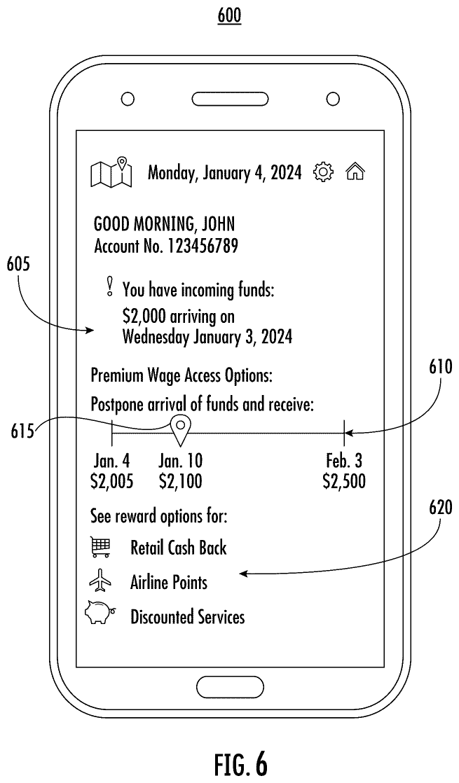

The scale refers to an interactive display (e.g., scale 610, as described below with reference to FIG. 6) presented to a user via a graphical user interface (e.g., GUI 600) of the client computing device 160 (e.g., via client application 168) that includes a movable element (e.g., movable element 615) along a pathway. The generated scale may also include indications (e.g., icons, markings, etc.) that provide an indication of the one or more rewards associated with each of the one or more durations. That is, each of the one or more durations included in the generated scale may correspond to a reward that the user may receive if the user selects to delay a transmittal of the incoming resource allocation for the corresponding duration. The reward may include an interest rate accrued on the incoming resource allocation, a bonus amount of funds, a discount on one or more services offered by the provider institution and/or a third-party entity, an amount of credit associated with a third-party entity, points associated with a rewards account of the user (e.g., a rewards account held at the provider institution and/or at a third-party entity), and so on. In some embodiments, the reward processing circuit 128 may be configured to determine the one or more rewards associated with each of the one or more durations. The one or more rewards may be unique to the user associated with the incoming resource allocation depending on the user information retrieved at process 414.

As described in greater detail with reference to FIG. 6, the user interface may include one or more selectable elements (e.g., rewards options 620) with which the user may change/update the rewards included in the scale. For example, if the scale includes rewards based on an interest rate earned on a deposit amount, the user may engage with at least one of the one or more selectable elements to view, via the graphical user interface, rewards including credit vouchers from one or more provider entities, an amount of bonus points from one or more provider entities, discounted services from the provider institution, and so on. In some embodiments, the graphical user interface may further include a selectable element configured to, when engaged with/clicked on by a user, connect the user to a representative of the provider institution. The representative of the provider institution may include a virtual agent (e.g., a chatbot) and/or a live agent (e.g., a human representative).

The provider computing system 110 may be configured to update and provide the generated scale based on the user information and contextual information at process 418. That is, as the provider computing system 110 retrieves updated information from one or more internal and/or external data sources, the provider computing system 110 may be configured to update the generated scale such that the scale reflects the updated information. The updated information may include real-time economic metrics retrieved from a third-party data source, updated regulatory requirements for financial institutions, updated discounts offered by one or more provider entities associated with the third-party computing system 150, and so on. For example, the provider computing system 110 may receive updated rates from a third-party computing system 150 that provides real-time market interest rates and may update the rewards included in the scale to reflect the updated rates. The scale displayed on a graphical user interface, once updated, may include updated durations and/or updated rewards associated with each of the durations.

At process 420, the provider computing system 110 may be configured to receive a selected duration from the one or more durations. In one embodiment, as mentioned above, the selected duration is a time duration. In this situation, the selected time duration refers to the period of time over which the user chooses to delay the transmittal of the incoming resource allocation. The selected duration may be received via a graphical user interface (e.g., GUI 600) presented on the client computing device 160 via the client application 168. In some embodiments, the selected duration is a one-time selection. That is, the one-time selection refers to a duration for which the incoming resource allocation associated with the indication received at process 412 may be delayed. In other embodiments, the selected duration may be a scheduled selection for all incoming resource allocations associated with the user. In this case, the scheduled selection may cause a delay of all incoming resource allocations associated with the user account for the selected duration. For example, a transaction schedule associated with the user account (e.g., stored in the account database 142) may include an incoming deposit of funds (e.g., $100, $2,000, $5,000, etc.) according to a regular frequency/pattern (e.g., every other Friday, twice per month, the first of the month, etc.). In this example, a scheduled selection of a duration may cause each of the incoming deposits of funds included in the transaction schedule to be delayed according to the selected duration.

After receiving the selected duration at process 420, the provider computing system 110 may be configured to withhold the incoming resource allocation for the selected duration at process 422. For example, if the incoming resource allocation includes a direct deposit of an amount of currency into a checking account associated with the user, the provider computing system 110 may be configured to transmit the direct deposit to the checking account only after an expiration of the selected duration (e.g., after an expiration of a time duration, after a termination of an event, etc.). Therefore, the user configured to receive the direct deposit may not have access to these funds until after the expiration of the selected duration.

In some embodiments, the provider computing system 110 may be configured to store the incoming resource allocation in a designated account associated with the provider institution. In some embodiments, the provider computing system 110 may be configured to generate a new account that is specific to the user and to assign a temporary account value that is unique to the user (e.g., via a random number generator plus a code/value that designates it as an income holding account). The new account may be linked to the user account initially configured to receive the incoming resource allocation, and to no other account. In some embodiments, the new account may be a temporary account that is deleted by the provider computing system 110 once the incoming resource allocation is released to the user account initially configured to receive the incoming resource allocation (e.g., after the selected duration of delay has expired). Automatically deleting the temporary account upon completion of the duration of delay is not a well-understood, routine, or conventional activity. Furthermore, the provider computing system 110 reduces memory occupancy and improves processing power. Alternatively or additionally, in some embodiments, the temporary account may be utilized by the provider computing system 110 to store the incoming resource allocation but may not be deleted after the completion of the duration of delay.

For example, the temporary account may be a reserves account that includes funds inaccessible to the user. By designating the incoming resource allocation to a specific reserve account, the provider institution may rely on these funds for meeting regulatory requirements (e.g., a liquidity requirement, a tier 1 capital requirement, etc.) because the funds are inaccessible to the user for immediate withdrawal. In some embodiments, the user may be configured to access the incoming resource allocation in advance of the expiration of the selected duration for a fee. In some embodiments, the user may designate an account associated with the provider institution in which the incoming resource allocation may be held until the expiration of the selected duration. Alternatively or additionally, in some embodiments, the incoming resource allocation may be stored/deposited in the user's account initially configured to receive the incoming resource delay, but the provider institution may freeze the incoming resource allocation for the selected duration such that the user cannot access the incoming resource allocation until completion of the selected duration. In such an embodiment, the user may be configured to access the incoming resource allocation in advance of the expiration of the selected duration for a fee.

After the expiration of the selected duration, the provider computing system 110 may be configured to transmit the incoming resource allocation and a reward subsequent to the selected duration at process 424. The reward may be the reward associated with the selected duration as indicated by the scale provided to the user at process 418.

As an example operation of method 400, a financial institution (e.g., a provider institution associated with the provider computing system 110) may receive an ACH file that indicates that a user is scheduled to be paid by the user's employer (e.g., a third party associated with the third-party computing system 150) on Friday, Apr. 19, 2024. The financial institution may receive the ACH file on Tuesday, Apr. 16, 2024, and the ACH file may indicate that the user is scheduled to receive $2,000 as a direct deposit into a checking account held the financial institution. The user may receive a plurality of options via the scale generated at process 416 of method 400 for delaying the $2,000 direct deposit. The plurality of options may be generated by an AI model and may include one or more durations. The one or more durations may include a time duration (e.g., two days, one week, one month, etc.), an event (e.g., an increase in ten market points, an interest rate of 5.5%, and interest rate of 6%, etc.), and/or a combination of a time duration and an event (e.g., a time duration of one week after an increase in ten market points, a time duration of one month after the interest rate reaches 6%, a time duration until an interest rate falls to 5%, etc.). The plurality of options may further include one or more rewards retrieved from the reward database 144 and corresponding to each of the one or more durations. The one or more rewards may include points and/or discounts associated with a third-party entity at which the user has an account (e.g., a retail merchant, a streaming service, an airline, a credit lender, etc.), a discount on a service offered by the provider institution (e.g., a discounted account fee, relief of a foreign transaction fee, etc.), an interest rate earned on the direct deposit amount, and so on. In this example, the user may choose to delay the direct deposit by two weeks and may choose to receive interest on the $2,000 amount according to the market interest rates. Therefore, if the market interest rate is 6%, the user receives a direct deposit of $2,120 into the checking account on Friday, May 3, 2024, rather than a direct deposit of $2,000 on Friday, Apr. 19, 2024.

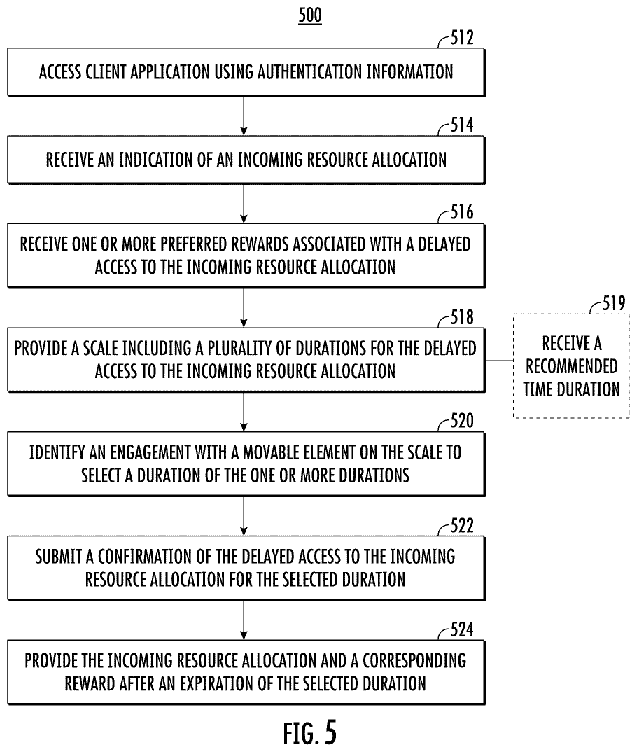

Referring now to FIG. 5, a method 500 of determining a dynamic incoming resource allocation delay with rewards from a perspective of the client computing device 160 is shown, according to an example embodiment. It should be understood that not all methods steps may be performed to “complete” the method. Certain steps/processes may be omitted in other embodiments, and still fall within the scope of the present disclosure.

In some embodiments, the method 500 may begin upon a user accessing the client application 168 (e.g., via the client computing device 160) at process 512. The user may submit at least one authentication credential (e.g., a username, a password, a pin code, a biometric such as a facial scan or a fingerprint, a combination thereof, etc.) to access the client application 168. The client application 168 may, via the network interface circuit 164 of the client computing device 160, transmit the authentication credential to the provider computing system 110. The provider computing system 110 may validate/verify the authentication credential. In some embodiments, the client application 168 may itself validate/verify the authentication credentials.

After the user submits the authentication information and accesses the client application 168 at process 512, the client computing device 160 may receive an indication of an incoming resource allocation at process 514. In some embodiments, the provider computing system 110 may first receive the indication of an incoming resource allocation from the third-party computing system 150. That is, the third-party computing system 150 may be associated with an employer of the user, as described above. In some embodiments, the indication of the incoming resource allocation may include a push notification, a text message, an email, or other communication from the provider computing system 110 to the client computing device 160 via the client application 168. For example, the client application 168 may be configured to transmit a push notification on Tuesday, Apr. 16, 2024 (e.g., upon receiving an ACH file, as described above), indicating that the user is scheduled to receive a direct deposit of $2,000 on Friday, Apr. 19, 2024.

In some embodiments, the method 500 may optionally include process 516, at which the client computing device 160 may receive one or more preferred rewards associated with a delayed access to the incoming resource allocation. The client computing device 160 may retrieve the one or more preferred rewards from the reward database 144 or the client computing device 160 may receive the one or more preferred rewards as a selection from the user via a GUI presented via the client application 168. In some embodiments, the user may select the one or more preferred rewards in response to a plurality of options presented to the user. The plurality of options refers to one or more rewards corresponding to the one or more eligible channels/means stored in the reward database 144. The one or more rewards may include points and/or discounts associated with a third-party entity at which the user has an account (e.g., a retail merchant, a streaming service, an airline, a credit lender, etc.), a discount on a service offered by the provider institution (e.g., a discounted account fee, relief of a foreign transaction fee, etc.), an interest rate earned on the direct deposit amount, and so on. For example, a user with a rewards account associated with an airline provider may designate that rewards account as a preferred reward. That is, the user may have previously designated the rewards account with the airline provider as the preferred reward, and the preferred reward may be stored in associated with the user account in the reward database 144. Alternatively, the user may make a selection on a GUI presented via the client computing device 160 that selects the rewards account with the airline provider as the preferred reward. In this example, the rewards included in a scale generated by the provider computing system 110 may be in terms of an amount of bonus miles that the user may receive in exchange for a delayed access to the incoming resource allocation.

At process 518, the client computing device 160 may provide a scale including a plurality of durations for the delayed access to the incoming resource allocation. In one embodiment, the scale provided at process 518 may include the scale generated by the provider computing system 110 at process 416 of method 400. In another embodiment, the client computing device 160 may generate the scale based on information retrieved by the client application 168 from the provider computing system 110 and/or the third-party computing system 150. In some embodiments, the client computing device 160 may retrievably store, via the client application 168, a scale. The stored scale may include a scale previously generated by the provider computing system 110 and/or the client computing device 160. In this embodiment, the client computing device 160 may be configured to retrieve the stored scale at process 518. Furthermore, the client computing device 160 may populate the stored scale according to updated information relating to the indication of the incoming resource allocation received at step 514, the one or more preferred rewards received at step 516, contextual information retrieved from the third-party computing system 150, and so on. The stored scale populated with the updated information may then be provided to the user via the client computing device 160.

The method 500 may optionally include receiving a recommended duration from the plurality of durations at process 519. In some embodiments, the recommended duration may be presented to the user via a GUI (e.g., GUI 700, as described in greater detail below). The recommended duration may be generated by the AI model 204, as described above.

After receiving the scale at process 518, and, optionally, the recommended duration at process 519, the client computing device 160 may identify an engagement with a movable element (e.g., movable element 615) on the scale at process 520. The engagement with the movable element may refer to a user dragging/sliding the movable element to a point along the scale. The point along the scale may correspond to a duration such that the engagement with the movable element provides a selection of a duration of the one or more durations at process 520. The selected duration refers to a period over which a transmittal of the incoming resource allocation to the user may be delayed.

The client computing device 160 may submit, to the provider computing system 110 via the client application 168, a confirmation of the delayed access to the incoming resource allocation for the selected duration at process 522. For example, the user may first submit the confirmation via the GUI 700, as described below with reference to FIG. 7. After confirming the delayed access at process 522, the client computing device 160 may provide the incoming resource allocation and a corresponding reward to the user after an expiration of the selected duration at process 524. For example, providing the incoming resource allocation and the corresponding reward may include receiving the incoming resource allocation via the client application 168 from the provider computing system 110 such that the user may access the incoming resource allocation (e.g., a deposit of funds) from the client application 168 on the client computing device 160

Referring to FIG. 6, a GUI 600 is shown. The GUI 600 may be generated by the provider computing system 110 for display on the client computing device 160. In some embodiments, the GUI 600 may be displayed to a user during a session with the client application 168. The session with the client application 168 may refer to an engagement/interaction with the client application 168. That is, the session may begin when a user successfully accesses the client application 168 using authentication information (e.g., at process 512 of method 500). The session may end when a user exits/logs out of/closes the client application 168.

The GUI 600 may provide information be associated with a user account held at the provider computing system 110. As shown in FIG. 6, the GUI 600 may include a name and an account number associated with the user account. In some embodiments, the GUI 600 may include an indication of an incoming resource allocation 605 (e.g., the indication of incoming resource allocation received at process 514 of method 500). The indication of the incoming resource allocation 605 may include an amount (e.g., $2,000) and a scheduled arrival (e.g., Wednesday, Jan. 3, 2024) of the incoming resource allocation.

The GUI 600 may present a dynamic scale 610 (e.g., the scale generated at process 416 of method 400 and/or the scale received by the user at process 518 of method 500) to the user associated with the client computing device 160. The dynamic scale 610 may include one or more durations and a reward corresponding to the one or more durations. In some embodiments, the one or more durations may include one or more time durations. When the one or more durations include one or more time durations, the dynamic scale 610 may include a lower end and an upper end. The lower end refers to a shortest time duration that the user may select for delayed access to the incoming resource allocation. The upper end refers to a longest time duration for which they user may choose to delay transmittal of the incoming resource allocation.

In some embodiments, the dynamic scale 610 includes a movable element 615. The movable element 615 is configured to display, as it is engaged with (e.g., by a user), consecutive durations and the reward corresponding to each of the consecutive durations. In some embodiments, the consecutive durations may include a series of time durations between the lower end and the upper end of the dynamic scale 610. In some embodiments, the consecutive durations may include a series of possible conditions relating to a type of event. For example, the type of event may refer to a market condition (e.g., an increase in market points, an interest rate, etc.). Therefore, in this example, the series of possible conditions included in the dynamic scale 610 may include a range of values associated with the market condition. The range of values associated with the market condition may further include a low end (e.g., an increase of two market points, an interest rate of 3%, etc.) and a high end (e.g., an increase of 20 market points, an interest rate of 7%, etc.). The consecutive durations may then include the series of possible conditions between the low end and the high end of the dynamic scale 610.

The GUI 600 may include one or more rewards or incentive options 620. The one or more rewards options 620 refer to a form of rewards (e.g., in addition to the form of rewards included in the dynamic scale 610) that the user may receive in response to selecting delayed transmittal of the incoming resource allocation to the user. In some embodiments, the one or more rewards options may include discounted services offered by the provider institution and/or a third-party entity. For example, the rewards options 620 may include retail cash back, airline points, discounted services, and so on.

Referring to FIG. 7, a GUI 700 is shown. The GUI 700 may be generated by the provider computing system 110 for display on the client computing device 160. In some embodiments, the GUI 700 may be displayed to a user during a session with the client application 168.

As shown in FIG. 7, the GUI 700 may include information corresponding to a user account associated with the user accessing the client application 168. For example, the GUI 700 may include the name, the account number, and the indication of the incoming resource allocation 605, as described above with reference to FIG. 6.

In some embodiments, the GUI 700 may include a transaction calendar 705 associated with the user account. The transaction calendar 705 refers to a display of upcoming transactions (e.g., scheduled withdrawals, payments due, scheduled deposits, etc.) associated with the user account. For example, the transaction calendar 705 may include a display of transactions scheduled to occur in the user account over a period of a particular month (e.g., January 2024).

The GUI 700 may also display, via the transaction calendar 705, one or more transaction indications 710. The transaction indications 710 may refer to an indication (e.g., represented in FIG. 7 by an exclamation icon) of a transaction scheduled to occur on a specific date included in the transaction calendar 705. For example, the provider computing system 110 may identify, via the processing circuit 119, that a user account associated with the user accessing the GUI 700 may have three scheduled transactions during the month of January. Therefore, each of the three scheduled transactions may be represented by a transaction indication 710 (e.g., an exclamation icon) on the transaction calendar 705 for the month of January. In some embodiments, the transaction indication 710 may be a selectable element such that a user may engage with/click on the transaction indication 710 to view additional information (e.g., a transaction amount, a transaction type, one or more parties associated with the transaction, etc.) related to the transaction associated with that transaction indication 710.

In some embodiments, the GUI 700 may include a recommendation 715. The recommendation 715 refers to a recommended delay for a transmittal of the incoming resource allocation. The recommended delay may be determined by the AI model 204 based on one or more transactions included in the transaction calendar 705. For example, the recommendation 715 may suggest that the user delay access to a incoming resource allocation scheduled to arrive on Jan. 3, 2024, until Jan. 15, 2024. In this example, the recommendation 715 may indicated that the user has a payment due (e.g., rent, credit card payment, etc.) on Jan. 16, 2024.

As another example, the provider computing system 110 may generate the recommendation 715 based on an interest of the provider institution. For example, at quarter end, the provider institution may be required to show a regulating entity (e.g., a government entity) that they have a certain deposit ratio. In this example, if the provider institution requires additional deposits in order to satisfy the threshold deposit ratio required by the regulating entity at quarter end, the recommendation 715 may include a recommendation to delay access to the incoming resource allocation until the beginning of a new quarter.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include a general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations may depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A provider computing system associated with a provider institution, the provider computing system comprising:
at least one processing circuit having at least one processor coupled to at least one memory device, the at least one memory device storing instructions thereon that, when executed by the at least one processor, cause the at least one processing circuit to perform operations comprising:
communicatively coupling to a third-party computing system by receiving a credential utilized by the third-party computing system and associated with a user;
receiving an indication of an authentication of the credential and subsequently receiving an indication of an incoming resource allocation associated with the user;
retrieving user information relating to the incoming resource allocation;
generating, based on the user information, a scale comprising a movable element for display via a user device associated with the user, wherein the scale comprises one or more durations and one or more rewards associated with each of the one or more durations;
updating and providing the generated scale based on at least one of the user information or contextual information, wherein the generated scale is dynamically updated based on the incoming resource allocation and the at least one of the user information or the contextual information;
receiving, from the user and via the user device, a selected duration of the one or more durations;
withholding the incoming resource allocation for the selected duration; and
transmitting the incoming resource allocation and a reward subsequent to the selected duration.

2. The provider computing system of claim 1, wherein the instructions, when executed by the at least one processor, further cause the at least one processing circuit to perform operations comprising receiving the user information from one or more third-party providers via at least one API call.

3. The provider computing system of claim 1, wherein an engagement with the movable element causes a display of a duration and a reward corresponding to the displayed duration for a series of points along the generated scale.

4. The provider computing system of claim 1, wherein the instructions, when executed by the at least one processor, further cause the at least one processing circuit to perform operations comprising:
training, using a training dataset comprising the user information, an artificial intelligence (AI) model;
determining, using the trained AI model, a recommended duration from the one or more durations; and
presenting, to the user via the user device, the recommended duration.

5. The provider computing system of claim 4, wherein the instructions, when executed by the at least one processor, further cause the at least one processing circuit to perform operations comprising:
receiving, from the user device, a response to the recommended duration, wherein the response to the recommended duration comprises an approval of the recommended duration or a denial of the recommended duration.

6. The provider computing system of claim 1, wherein the contextual information comprises real-time economic metrics, such that the updated scale comprises the one or more rewards based on the real-time economic metrics.

7. The provider computing system of claim 1, wherein the instructions, when executed by the at least one processor, further cause the at least one processing circuit to perform operations comprising:
receiving, from the user device, a rewards preference;
storing the rewards preference as user information in a database of the provider computing system; and
determining the one or more rewards associated with the one or more durations based on the stored rewards preference.

8. The provider computing system of claim 1, wherein the selected duration further comprises a one-time selection or a scheduled selection for all or a selected subset of incoming resource allocations associated with the user.

9. A method comprising:
communicatively coupling, by a provider computing system, to a third-party computing system by receiving a credential utilized by the third-party computing system and associated with a user;
receiving, by the provider computing system, an indication of an authentication of the credential and subsequently receiving an indication of an incoming resource allocation associated with the user;
retrieving, by the provider computing system, user information relating to the incoming resource allocation;
generating, by the provider computing system and based on the user information, a scale comprising a movable element for display via a user device associated with the user, wherein the scale comprises one or more durations and one or more rewards associated with each of the one or more durations;
updating and providing, by the provider computing system, the generated scale based on at least one of the user information or contextual information, wherein the generated scale is dynamically updated based on the incoming resource allocation and the at least one of the user information or the contextual information;
receiving, by the provider computing system, from the user and via the user device, a selected duration of the one or more durations;
withholding, by the provider computing system, the incoming resource allocation for the selected duration; and
transmitting, by the provider computing system, the incoming resource allocation and a reward subsequent to the selected duration.

10. The method of claim 9, wherein the method further comprises:
generating, by the providing computing system, a temporary account that receives the incoming resource allocation prior to distribution an account of the user; and
deleting, by the provider computing system, the temporary account responsive to transmitting the incoming resource allocation to the account of the user from the temporary account.

11. The method of claim 9, wherein the method further comprises:
training, by the provider computing system using a training dataset comprising the user information, an artificial intelligence (AI) model;
determining, by the provider computing system using the trained AI model, a recommended duration from the one or more durations;
presenting, by the provider computing system and to the user via the user device, the recommended duration; and
receiving, by the provider computing system and from the user via the user device, a response to the recommended duration, wherein the response to the recommended duration comprises an approval of the recommended duration or a denial of the recommended duration.

12. The method of claim 11, wherein the AI model comprises a generative AI model.

13. The method of claim 12, wherein the generative AI model is further trained using one or more previous incoming resource allocation delays associated with the user.

14. The method of claim 9, wherein the method further comprises:
receiving, by the provider computing system and from the user device, a rewards preference;
storing, by the provider computing system, the rewards preference as user information in a database of the provider computing system; and
determining, by the provider computing system, the one or more rewards associated with the one or more durations based on the stored rewards preference.

15. The method of claim 9, wherein an engagement with the movable element causes a display of a duration and a reward corresponding to the duration for a series of points along the generated scale.

16. The method of claim 9, wherein the one or more durations comprise at least one of a time duration or an event.

17. A non-transitory computer-readable medium including instructions stored thereon that, when executed by at least one processing circuit of a provider computing system associated with a provider institution, cause the at least one processing circuit to perform operations comprising:
communicatively coupling to a third-party computing system by receiving a credential utilized by the third-party computing system and associated with a user;
receiving an indication of an authentication of the credential and subsequently receiving an indication of an incoming resource allocation associated with the user;
retrieving user information relating to the incoming resource allocation;
generating, based on the user information, a scale comprising a movable element for display via a user device associated with the user, wherein the scale comprises one or more durations and one or more rewards associated with each of the one or more durations;
updating and providing the generated scale based on at least one of the user information or contextual information, wherein the generated scale is dynamically updated based on the incoming resource allocation and the at least one of the user information or the contextual information;
receiving, from the user via the user device, a selected duration of the one or more durations;
withholding the incoming resource allocation for the selected duration; and
transmitting the incoming resource allocation and a reward subsequent to the selected duration.

18. The non-transitory computer-readable medium of claim 17, wherein the instructions, when executed by the at least one processing circuit, further cause the at least one processing circuit to perform operations comprising:
training, using a training dataset comprising the user information, an artificial intelligence (AI) model;
determining, using the trained AI model, a recommended duration from the one or more durations;
presenting, via the user device, the recommended duration; and
receiving, via the user device, a response to the recommended duration, wherein the response to the recommended duration comprises an approval of the recommended duration or a denial of the recommended duration.

19. The non-transitory computer-readable medium of claim 17, wherein the operations further comprise:
receiving, from the user device, a rewards preference;
storing the rewards preference as user information in a database of the provider computing system; and
determining the one or more rewards associated with the one or more durations based on the stored rewards preference.

20. The non-transitory computer-readable medium of claim 17, wherein the contextual information comprises real-time economic metrics, such that the updated scale comprises the one or more rewards based on the real-time economic metrics.
